(19) United States
(12) Patent Application Publication
(10) Pub. No.: US 2009/0236032 A1
(43) Pub. Date: Sep. 24, 2009

(54) METHOD OF CONTINUOUSLY MANUFACTURING A COMPOUND PIPE COMPRISING A PIPE SOCKET AND APPARATUS FOR IMPLEMENTING THE METHOD

(76) Inventor: Ralph Peter Hegler, Bad Kissingen (DE)

Correspondence Address: James B. Conte;HUSCH BLACKWELL SANDERS LLP WELSH & KATZ, 22nd Floor, 120 South Riverside Plaza, Chicago, IL, 60606-3912, US

(21) Appl. No.: 12/395,108

(22) Filed: Feb. 27, 2009

(30) Foreign Application Priority Data
Mar. 18, 2008 (EP) 08 004 992.7

(51) Int. Cl. B32B 37/00

(52) U.S. Cl. 156/199; 156/391

(57) ABSTRACT

During the manufacture of a compound pipe, which is composed of an internal tube and a corrugated external tube, a slight overpressure relative to atmospheric pressure pa is applied to the inside of the internal tube, which is guided across a calibrating mandrel during the manufacture. At the transition to the formation of a pipe socket, a partial vacuum p3 relative to atmospheric pressure pa is temporarily applied the internal tube.

### BACKGROUND OF THE INVENTION

1. Field of the Invention

The invention relates to a method of continuously producing a compound pipe comprising a smooth internal pipe and an external pipe that is welded together with the internal pipe and provided with hollow elevations, a pipe socket, and a central longitudinal axis, the method comprising the following steps:
extruding an external tube concentrically with the central longitudinal axis in a conveying direction;
providing the external tube with corrugations comprising hollow elevations and troughs by partial vacuum applied from outside;
extruding an internal tube into the external tube concentrically with the central longitudinal axis;
passing the internal tube across a calibrating mandrel and welding together the internal tube and the troughs of the external tube;
expanding the external tube at given distances to form an expanded area by applying the partial vacuum from outside so as to produce a pipe socket;
applying a gas at a pressure p4 above atmospheric pressure to the inside of the internal tube and pressing the internal tube full face against the expanded area of the external tube so as to finish the pipe socket;
forming a transition portion between the pipe socket and an adjacent trough which leads in the conveying direction, the transition portion being comprised of the internal tube and the external tube and directed outwardly in relation to the central longitudinal axis;
wherein the transition portion, in an area between the internal tube and the external tube, is vented into an adjacent hollow elevation by providing the external tube, in the area of the transition portion, with at least one overflow passage that passes through the adjacent trough and extends in the direction of the central longitudinal axis.

Furthermore, the invention relates to an apparatus for implementing the method according to the invention,
wherein half shells are disposed for guided circulation in a conveying direction, which half shells are provided with annular mold recesses and which combine in pairs on a molding path so as to form a mold with a central longitudinal axis;
wherein the mold recesses are connected to partial-vacuum channels in the half shells;
wherein an extrusion head of at least one extruder is disposed upstream of the molding path;
wherein the extrusion head is provided with an outer die for extrusion of an external tube, and with an inner die, which is disposed downstream when seen in the conveying direction, for extrusion of an internal tube, and with a calibrating mandrel at its downstream end relative to the conveying direction;
wherein at least one gas duct exits the extrusion head between the outer die and the inner die;
wherein at least one additional gas duct exits the extrusion head between the inner die and the calibrating mandrel which may be supplied with both overpressure p1 relative to atmospheric pressure pa as well as partial vacuum p3;
wherein at least one pair of half shells is provided with a socket recess;
wherein a transition area, which is directed outwardly in relation to the central longitudinal axis, is formed on an annular rib that is located between the socket recess and an adjacent mold recess leading in the conveying direction; and
wherein a recess is provided in the annular rib which recess connects the transition area with said adjacent annular mold recess for forming a hollow elevation.

2. Background Art

A method of this type, a compound pipe of this type and an apparatus of this type are known from U.S. Pat. No. 7,238,317. The greater the nominal widths of the pipes, the more grow the hollow elevations and thus the increase in size of the pipe socket relative to the internal diameter of the compound pipe. This is due to the fact that the standard compound pipe is very often used as a spigot of the pipe, meaning that a compound pipe is inserted into the socket by its hollow elevations. The transition portions between the compound pipe that leads during in-line production and the pipe socket on the one hand, and the pipe socket and the lagging compound pipe on the other, possess considerable radial extension. In particular the transition portion between a compound pipe and socket, which remains after separation of the extruded continuous run of pipe, must possess pronounced radial extension i.e., must be directed steeply outwardly in relation to the central longitudinal axis, so that, upon insertion of the spigot into the socket as far as to the transition portion, there will be no dead space, nor considerable dead space, where dirt might deposit. The greater the nominal widths and/or the higher the production rate, the greater the risk that the internal tube does not adhere by its full face to the external tube in the vicinity of the transition portion and at the beginning and end of the socket. Full-face adherence, and thus welding, of the internal tube to the external tube in the vicinity of the transition portion is achieved by venting the transition portion, in an area between the internal tube and external tube, into an adjacent hollow elevation so that the external tube, in the area of the transition portion, is provided with at least one overflow passage which passes through the adjacent corrugation trough and extends in the direction of the central longitudinal axis. Although the idea behind this solution is excellent, it turned out that if production conditions are unfavorable, the overflow passage does not always have a sufficiently large free cross-section for the desired venting action to be achieved.

### SUMMARY OF THE INVENTION

Therefore, it is the object of the invention to embody a method and an apparatus of in each case the generic type which allow the overflow passage to be produced with a sufficiently free cross-section under any conditions.

According to the invention, in a method of continuously producing a compound pipe comprising a smooth internal pipe and an external pipe that is welded together with the internal pipe and provided with hollow elevations, a pipe socket, and a central longitudinal axis, the method comprising the following steps:
extruding an external tube concentrically with the central longitudinal axis in a conveying direction;
providing the external tube with corrugations comprising hollow elevations and troughs by partial vacuum applied from outside;
extruding an internal tube into the external tube concentrically with the central longitudinal axis;
passing the internal tube across a calibrating mandrel and welding together the internal tube and the troughs of the external tube;
expanding the external tube at given distances to form an expanded area by applying the partial vacuum from outside so as to produce a pipe socket;
applying a gas at a pressure p4 above atmospheric pressure to the inside of the internal tube and pressing the internal tube full face against the expanded area of the external tube so as to finish the pipe socket; and
forming a transition portion between the pipe socket and an adjacent trough which leads in the conveying direction, the transition portion being comprised of the internal tube and the external tube and directed outwardly in relation to the central longitudinal axis;
wherein the transition portion, in an area between the internal tube and the external tube, is vented into an adjacent hollow elevation by providing the external tube, in the area of the transition portion, with at least one overflow passage that passes through the adjacent trough and extends in the direction of the central longitudinal axis,
   this object is attained in such a way that prior to forming the overflow passage, there is an overpressure p1 relative to atmospheric pressure pa between the calibrating mandrel and the internal tube, and while the overflow passage is formed, there is a partial vacuum p3 relative to atmospheric pressure pa between the calibrating mandrel and the internal tube.

In an apparatus for implementing the method according to the invention,
wherein half shells are disposed for guided circulation in a conveying direction, which half shells are provided with annular mold recesses and which combine in pairs on a molding path so as to form a mold with a central longitudinal axis;
wherein the mold recesses are connected to partial-vacuum channels in the half shells;
wherein an extrusion head of at least one extruder is disposed upstream of the molding path;
wherein the extrusion head is provided with an outer die for extrusion of an external tube, and with an inner die, which is disposed downstream when seen in the conveying direction, for extrusion of an internal tube, and with a calibrating mandrel at its downstream end relative to the conveying direction;
wherein at least one gas duct exits the extrusion head between the outer die and the inner die;
wherein at least one additional gas duct exits the extrusion head between the inner die and the calibrating mandrel which may be supplied with both overpressure p1 relative to atmospheric pressure pa as well as partial vacuum p3;
wherein at least one pair of half shells is provided with a socket recess;
wherein a transition area, which is directed outwardly in relation to the central longitudinal axis, is formed on an annular rib that is located between the socket recess and an adjacent mold recess leading in the conveying direction; and
wherein a recess is provided in the annular rib which recess connects the transition area with said adjacent annular mold recess for forming a hollow elevation,
   this object is attained in such a way that relative to the conveying direction, a vent duct exits between the outer die and the inner die, the vent duct being continuously connected to atmosphere.

The gist of the invention is that during the manufacture of the compound pipe, which is usually provided with hollow elevations, there is a slight over-pressure between the calibrating mandrel and the internal tube in a manner which is known per se, with the result that a stable welded joint is attained between the internal tube and the corrugation troughs of the external tube, and that friction between internal tube and calibrating mandrel is eliminated. On the other hand, a slight partial vacuum is applied to the inside of the internal tube when the overflow passages are formed, which has a positive influence on the formation of the overflow passages because in this area, the internal tube comes to bear against the calibrating mandrel along a short portion of the production line so as to be cooled there. The direct contact with the calibrating mandrel causes this area of the internal tube to be reinforced to a greater extent than the other areas thereof, which prevents the plastic melt of the internal tube from partially clogging one or more overflow passages, in other words from reducing the free flow cross-section thereof. This does not affect the welded joint between the internal tube and the corrugation trough of the corrugation in this area.

Further features, advantages and details of the invention will become apparent from the ensuing description of an embodiment by means of the drawing.

### BRIEF DESCRIPTION OF THE DRAWING

FIG. 1 is a diagrammatic plan view of an installation for the manufacture of compound pipes with sockets, substantially comprised of two extruders, a molding machine and an aftercooler;

FIG. 2 is a horizontal sectional view of an extrusion head and the inlet of the molding machine;

FIG. 3 is a vertical partial longitudinal sectional view of details of the molding machine during the manufacture of a standard compound pipe;

FIG. 4 is a vertical partial longitudinal sectional view corresponding to FIG. 3 in a position just before the start of the manufacture of a compound pipe socket;

FIG. 5 is a vertical partial longitudinal sectional view corresponding to FIGS. 3 and 4 in a position during the manufacture of overflow passages;

FIG. 6 is a vertical partial longitudinal sectional view corresponding to FIGS. 3 to 5 during the manufacture of a transition portion;

FIG. 7 is a vertical partial longitudinal sectional view corresponding FIGS. 3 to 6 in a position after the formation of the transition portion and after the start of the manufacture of the compound pipe socket;

FIG. 8 is an enlarged partial sectional view along line VIII in FIG. 7;

FIG. 9 is a vertical partial longitudinal sectional view corresponding to FIGS. 3 to 7 in a position at the end of the manufacture of the pipe socket before the formation of overflow passages;

FIG. 10 is a vertical partial longitudinal sectional view corresponding to FIGS. 3 to 7 and 9 after the formation of overflow passages;

FIG. 11 is a vertical partial longitudinal sectional view corresponding to FIGS. 3 to 7 and 9, 10 during the manufacture of a standard compound pipe;

FIG. 12 is a compound pipe comprising a pipe socket which was produced using the installation;

FIG. 13 is a cross-sectional view of the compound pipe along line XIII-XIII in FIG. 12; and

FIG. 14 is a schematic diagram of the pressure control system.

### DESCRIPTION OF THE PREFERRED EMBODIMENT

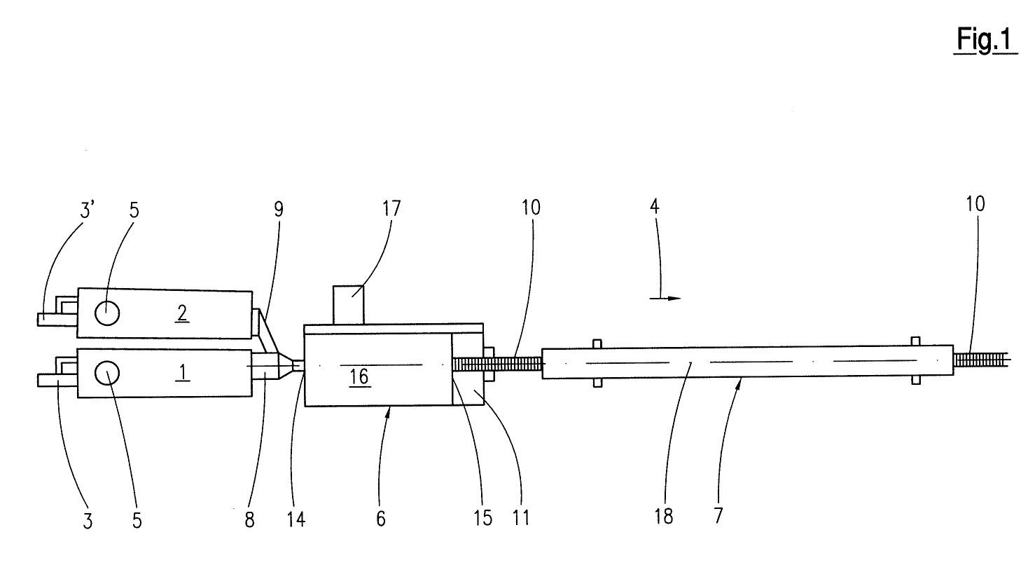

The installation shown in FIG. 1 for the manufacture of compound pipes comprises two extruders 1, 2. Each of them is driven by a variable speed drive motor 3 and 3′ which, relative to the conveying direction 4 of the entire installation, is provided upstream of the feed hoppers 5 of the extruders 1, 2.

Downstream of the extruders 1, 2 as seen in the conveying direction 4, provision is made for a molding machine 6, a so-called corrugator, which is followed by an aftercooler 7. A crosshead 8, which projects into the molding machine 6, is mounted on the extruder 1 which is in alignment with the molding machine 6 and the aftercooler 7. The other extruder 2, by the side of the extruder 1, is connected to the crosshead 8 by way of an injection channel 9 which projects laterally into the crosshead 8. As diagrammatically outlined in FIG. 1, a compound pipe 10 is molded in the molding machine 6; it leaves the molding machine 6 in the conveying direction 4 and is cooled in the aftercooler 7. Downstream of the aftercooler 7, it can then be cut into pieces of appropriate length.

The design of the molding machine 6 is known and common practice. It is described for example in U.S. Pat. No. 5,320,797, to which reference is made explicitly. It substantially comprises a machine bed 11 with half shells 12, 12′ disposed thereon, which are joined to each other to form two so-called chains 13, 13′. These chains 13, 13′ are guided along deflection rollers (not shown) at the upstream inlet 14 and the downstream outlet 15 relative to the conveying direction 4. When circulating in the conveying direction 4, they are guided in such a way that two half shells 12, 12′ are in each case combined to form a pair, with adjacent pairs of shells being in close contact in the conveying direction 4. A drive motor 17 serves for actuation of the half shells 12, 12′ which are combined on a molding path 16 so as to form pairs of shells.

The crosshead 8 comprises two melt channels which are concentric with a common central longitudinal axis 18, namely an inner melt channel 19 and an outer melt channel 20 which, relative to the conveying direction 4, terminate in a downstream inner die 21 and outer die 22. The inner melt channel 19 is connected to an injection channel 23 of the extruder 1 which is in alignment with the molding machine 6, whereas the outer melt channel 20 is connected to the injection channel 9 of the other extruder 2. Between the inner die 21 and the outer die 22, a gas duct 24 discharges from the crosshead 8, the gas duct 24 on the one hand being connectable to a source of compressed gas by way of a valve, allowing so-called stabilizing air to be blown in.

A calibrating mandrel 25, which is also concentric with the axis 18, is mounted on the extrusion head 8 at the downstream end thereof relative to the conveying direction 4. It has cooling channels 26 for cooling water which is supplied via a cooling-water flow pipe 27 and discharged via a cooling-water return pipe 28. Furthermore, an air pipe 29 is provided which is connected to a gas gap 30 which serves as an additional gas duct and, relative to the conveying direction 4, is located directly downstream of the inner die 21 between the extrusion head 8 and the calibrating mandrel 25. The air pipe 29 is connectable to a source of compressed gas on the one hand for stabilizing air to be blown in and to a partial vacuum on the other by means of a valve. The pipes 27, 28, 29 pass through an approximately tubular supply channel 31 which is provided in the extrusion head 8 concentrically with the axis 18.

The half shells 12, 12′ have annular mold recesses 32, 32′ that are disposed in succession at regular distances, each of them being connected to partial-vacuum channels 33. Upon arrival of the half shells 12, 12′ on the molding path 16, the partial-vacuum channels 33 reach partial-vacuum supply sources 35 and 36 so that partial vacuum is admitted to the mold recesses 32.

The plastic melt, which is supplied by the extruder 2 through the injection channel 9 and to the extrusion head 8, flows through the outer melt channel 20 to the outer die 22 where it is extruded to form an external tube 37. Owing to the partial vacuum, this tube 37 adheres to the mold recesses 32, 32′, thus forming a tube that is provided with annular hollow elevations 38. Plastic melt is supplied from the extruder 1 through the injection channel 23 to the extrusion head 8, flowing through the inner melt channel 19 towards the inner die 21 where it is discharged as an internal tube 39 that approaches the calibrating mandrel 25. The calibrating mandrel 25 expands slightly outwardly from the inner die 21 in the conveying direction 4 until the internal tube 39 bears against the corrugation troughs 40 of the external tube 37 where both of them are welded together. Once cooled and solidified, the internal tube 39 and the external tube 37 constitute the compound pipe 10.

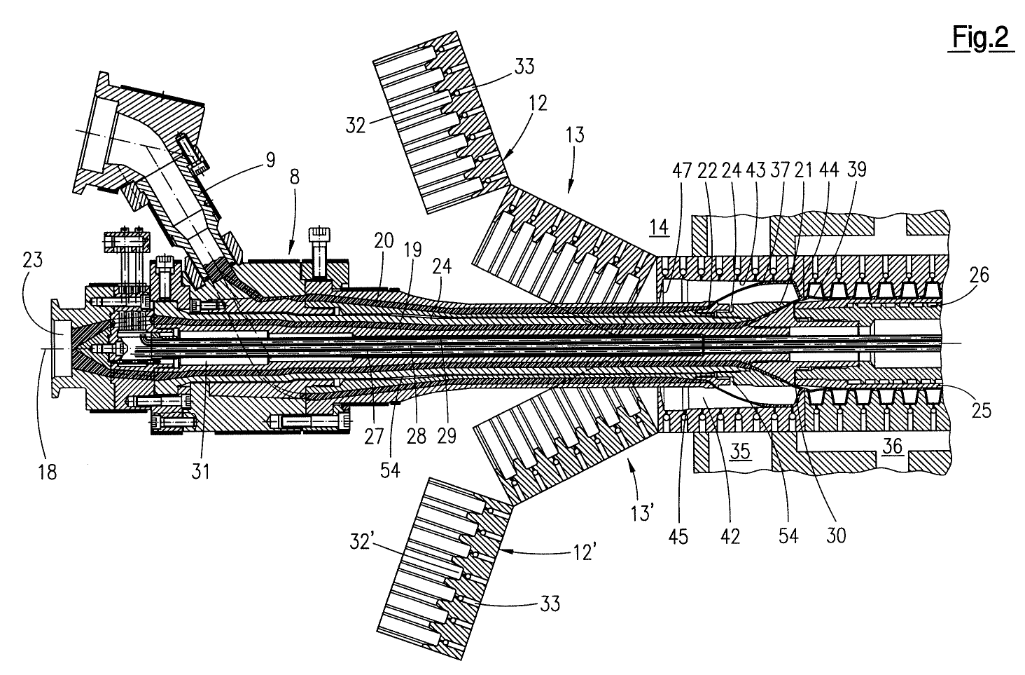

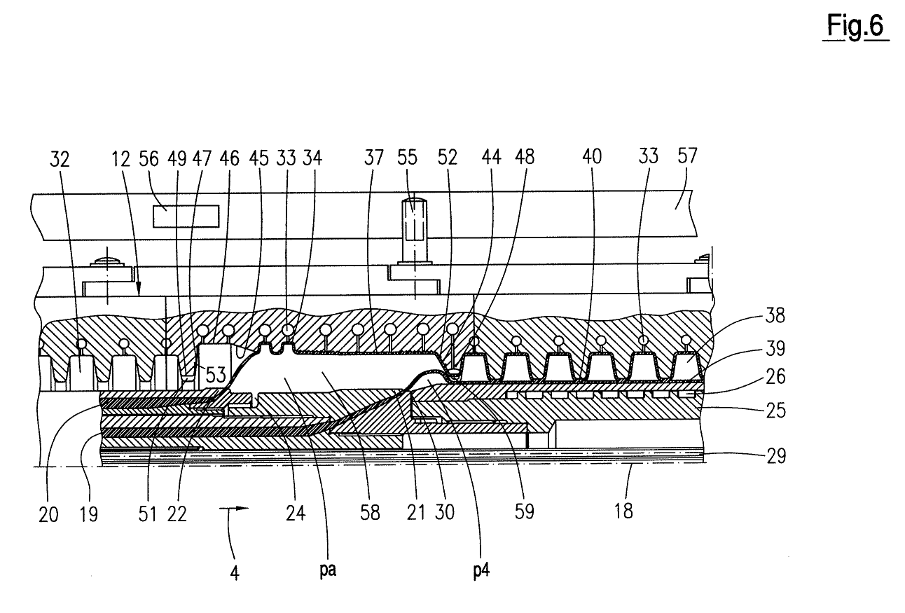

As can be seen in particular in FIGS. 2 to 7 and 9 to 11, the half shells 12, 12′ are designed for pipe sockets 41 to be formed at regular distances within the continuous compound pipe 10. To this end, a socket recess 42 is formed in a pair of half shells 12, 12′, the socket recess 42 thus having a substantially smooth, cylindrical wall 43. A transition area 44 is formed between the wall 43 of the socket recess 42 and the mold recess 32 that leads in the conveying direction 4. The lagging end, relative to the conveying direction 4, of the wall 43 of the socket recess 42 is followed by peripheral grooves 34 for reinforcement of the socket 41 and a truncated mold portion 45 where an outwardly expanding insert end 46 of the socket 41 is formed. This is again followed by a transition area 47 that leads to the next mold recess 32 which lags when seen in the conveying direction 4.

As far as previously described, the apparatus is substantially known from U.S. Pat. No. 6,458,311, to which reference is made explicitly.

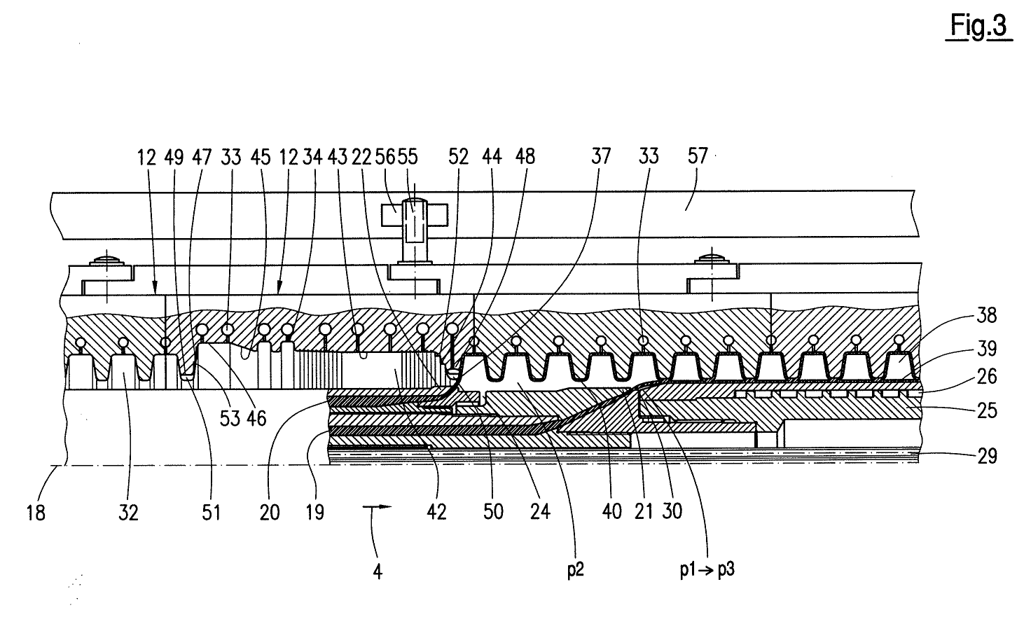

As can be seen in FIGS. 3 to 11, the transition area 44 that leads in the conveying direction and the transition area 47 that lags in the conveying direction 4 are provided with slotted recesses 50, 51 extending in the direction of the axis 18, the slotted recesses 50, 51 being formed in the vicinity of the corrugation trough 40 to be produced, strictly speaking on the annular rib 48 or 49 of the half shell 12, 12′, the annular rib 48 or 49 forming the respective transition area 44 or 47. These recesses 50, 51 thus connect the respective transition area 44 and 47 to the nearest adjacent annular hollow elevation 38. The recesses 50, 51 of each annular rib 48, 49 are interconnected by connecting grooves 52, 53 which extend along the periphery of the respective transition area 44 and 47 and are formed therein.

As can be seen in FIGS. 3 to 7 and 9 to 11, the half shell 12 that accommodates the socket recess 42 is sufficiently long for the annular ribs 48, 49 to be completely contained therein. Unlike in FIG. 2 which is merely a diagrammatic illustration in this regard, the separation of adjacent half shells 12 does not take place through the annular rib 48 and 49, which is advantageous in terms of manufacture. If the socket recess 42 is sufficiently long to extend across more than one half shell 12, then this applies correspondingly to these half shells 12.

Next to the gas duct 24 is provided a venting duct 54 which is either throttled correspondingly so as to be continuously connected to the atmosphere or may be opened to atmosphere by means of a corresponding valve.

A rod-shaped switch member 55, which is in a spatially fixed arrangement relative to the socket recess 42, is connected to the corresponding half shell 12 and operates a switch 56 by means of which the speed and thus the extrusion rate of the extruders 1, 2 are changed, and by means of which the supply of the gas duct 24 and the gas gap 30 is maintained. To this end, a retaining arm 57 is mounted on the molding machine 6 which extends in the conveying direction 4 above the half shells 12, 12′. This retaining arm 57 is where the switch 56 is mounted which is to be operated by the switch member 55. This switch 56 is operated as shown in FIG. 3. The tasks of modifying the speed of the extruder 2 that delivers the plastic melt for manufacture of the external tube 37, triggering the so-called stabilizing air that flows from the gas duct 24, triggering the gas gap 30 at the calibrating mandrel 25, and finally changing the speed and thus the extrusion rate of the extruder 1 which delivers the plastic melt for manufacture of the internal tube 39, take place via the software of a control system to which the switch 56, upon operation, transmits a reference signal.

During the manufacture of the standard corrugated compound pipe 10 in the way shown on the right of FIG. 3, the partial vacuum causes the external tube 37 to be retracted into the mold recesses 32 to which it adheres. A low overpressure p1 of 0.05 to 0.4 bar above atmospheric pa is admitted to the gas gap 30. Simultaneously, a low, but slightly higher overpressure p2 of 0.1 to 0.4 bar above atmospheric is admitted to the gas duct 24. This low overpressure p1 within the internal tube 39 prevents it from sticking to the calibrating mandrel 25 before it is welded to the external tube 37. FIG. 3 shows that the internal tube has been slightly lifted off the calibrating mandrel in the vicinity of the gas gap 30. The slightly higher overpressure between the external tube 37 and the internal tube 39 ensures that the internal tube 39 does not bulge radially outwardly into the hollow elevation 38 when the tubes 37, 39, which are welded together at the corrugation troughs 40, cool down to form the corrugated compound pipe 10. After cooling, there will be atmospheric pressure between the tubes 37, 39.

As soon as the transition area 44 has reached the vicinity of the outer die 22 in the instant shown in FIG. 3, the switch member 55 reaches the switch 56 which, when operated, causes the overpressure p1 to be removed from the gas gap 30. The overpressure p1, which is applied to the gas gap 30, is replaced by a partial vacuum p3 which causes the internal tube 39 next to the inner die 21 to closely adhere to the calibrating mandrel 25. This results in a more rapid cooling, and therefore reinforcement, of the internal tube 39. Simultaneously, the speed of the extruder 2 can be changed in such a way that a smaller or larger amount of melt per unit time is discharged from the outer die 22, causing the wall thickness of the external tube 37 to increase. In any way, the speed of the extruder 1 for forming the internal tube 39 is increased just before or immediately when the transition portion 61 is formed, causing the amount of melt, which is supplied for forming the internal tube 39 per unit time, to increase in particular for forming the transition portion.

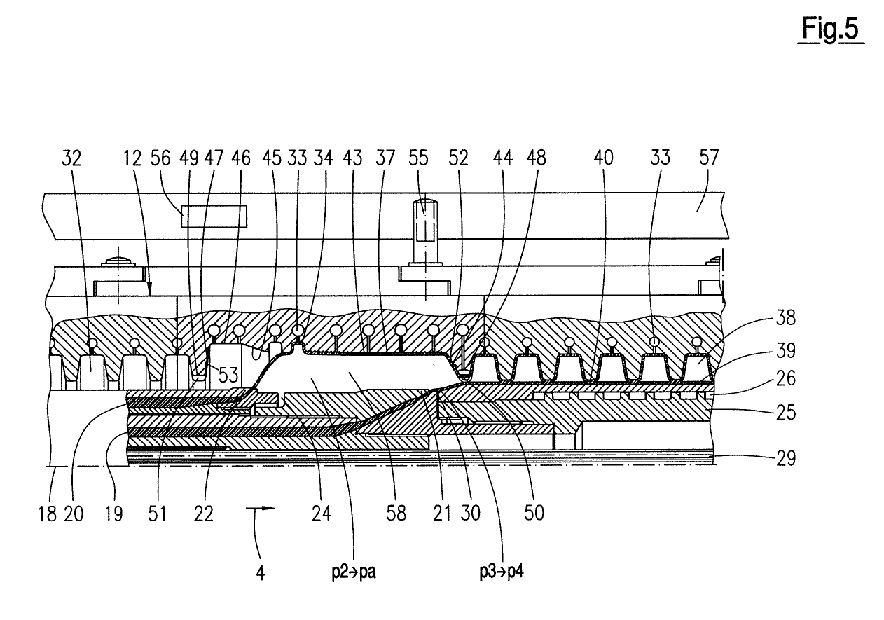

When the transition area 44 has moved across the gas gap 30 according to FIG. 5, the overpressure p2 in the clearance 58 is switched off and vented to the open air until atmospheric pressure pa is reached. As a partial vacuum is applied to the outside of the external tube 37 while there is atmospheric pressure pa in the clearance 58 between the external tube 37 and the internal tube 39, the external tube 37 adheres to the wall 43 of the socket recess 42.

When the transition area 44 has slightly moved across the internal die 21, the partial vacuum p3 of the air exiting the gas gap 30 is for instance switched to an overpressure p4 of approximately 0.1 to 0.45 bar. As the clearance 58 between the internal tube 39 and the external tube 37 is vented in the vicinity of the socket recess 42, the internal tube 39 is pressed outwardly against the external tube 37.

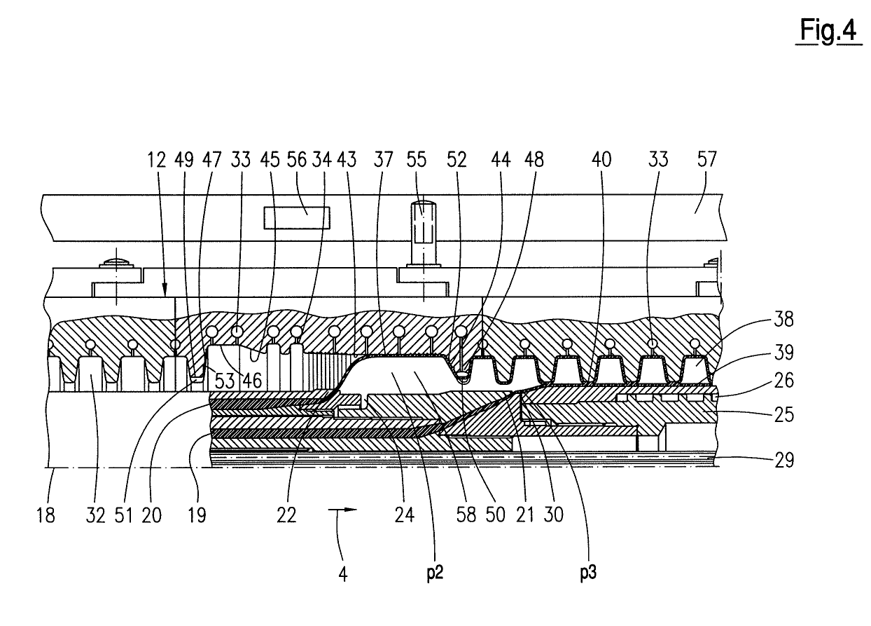

As can be seen from FIGS. 4 to 8, the external tube 37 adheres to the annular rib 48 and the transition area 44, with an overflow passage 59 leading into the adjacent hollow elevation 38 which is simultaneously formed in the vicinity of the slotted recesses 50. At the transition area 44, the external tube 37 adheres to the connecting grooves 52 as well, which causes connecting passages 60 to be produced in the external tube 37′ to be formed. The pressure inside the internal tube 39 causes the internal tube 39 to be pressed against the external tube 37 but it is not pressed or molded into the overflow passages 59 and into the connecting passages 60. Consequently, these passages 59 and ducts 60 are maintained between the external tube 37 and the internal tube 39, allowing the air in this region to flow into the hollow elevation 38 that leads in the conveying direction. In the transition portion 61 between the standard twin-pipe 10 and the in-line molded socket 41, the external tube 37 and the internal tube 39 are welded together nearly full face. There is however no such welded joint in the vicinity of the overflow passages 59 and the connecting passages 60. This design enables the transition portion 61 to be formed in such a way as to ascend strongly radially, in other words comparatively steeply, relative to the conveying direction 4. The internal tube 39 is not pressed into the overflow passages 59 because the part of the internal tube 39, which delimits the overflow passages 59 and the connecting passages 60, was reinforced on the calibrating mandrel during cooling.

While the pipe socket 41 is formed, the overpressure p4, which is applied to the internal tube 39 via the gas gap 30, may vary. This depends on the pipe diameter, the melt elasticity of the plastic material that is used, the wall thickness of the internal tube and other parameters.

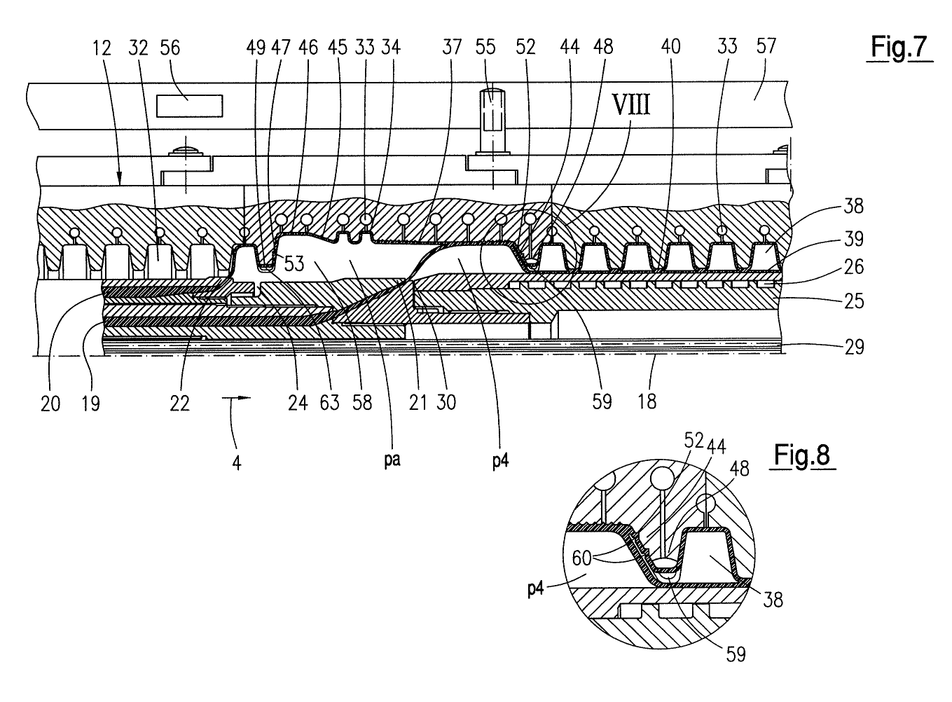

When the transition area 47 of the socket recess 42 moves across the outer die 22 according to FIG. 7, the external tube 37 adheres to the transition area 47 and into the connecting grooves 53 formed therein, which causes connecting passages 62 to be formed in the external tube 37. Afterwards, the external tube adheres to the annular gap 49 and is molded into the slotted recesses 51 so as to form overflow passages 63.

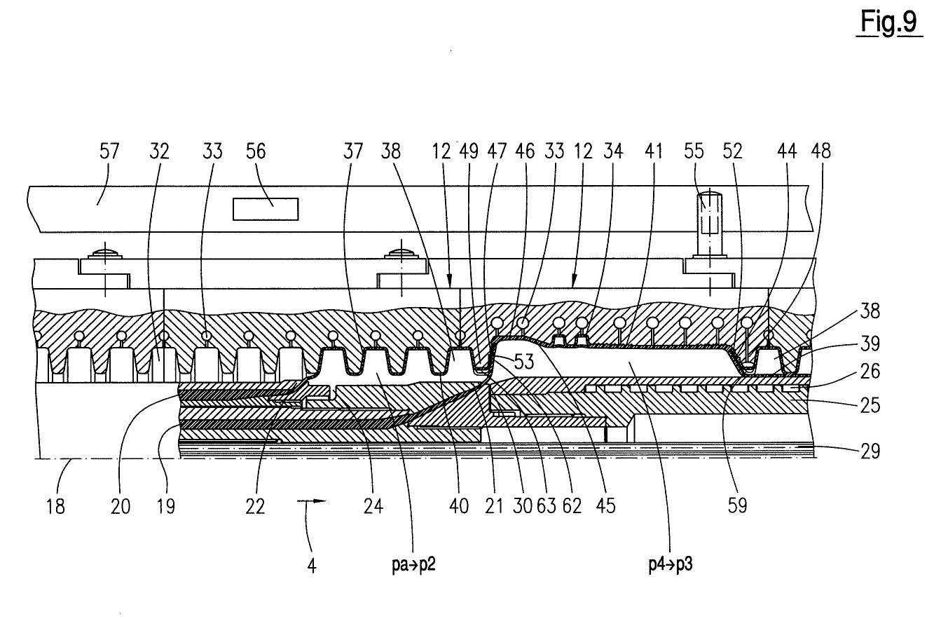

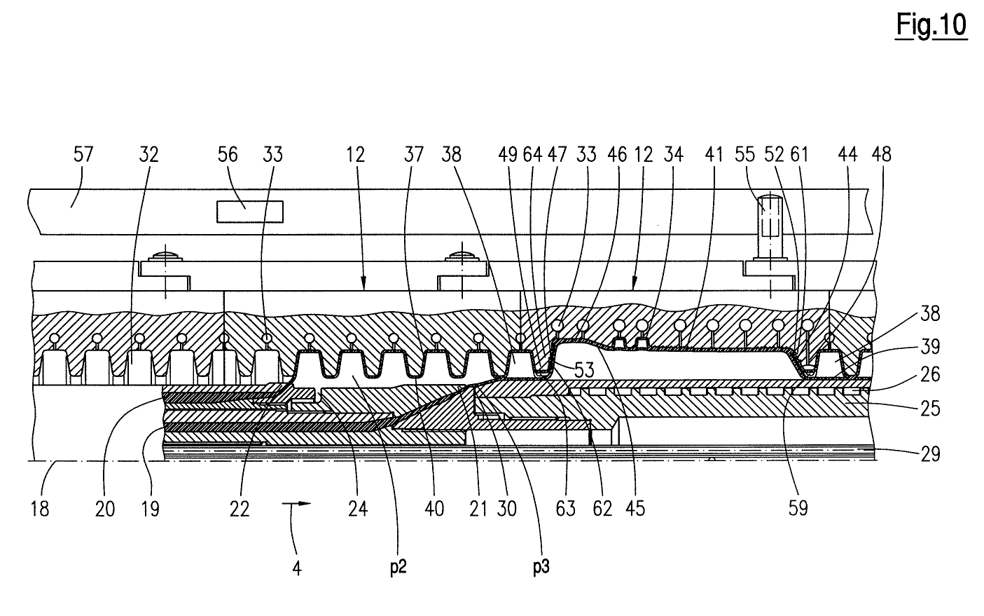

When the transition area 47 has reached the inner die 21 according to FIGS. 9 and 10, the overpressure p4 at the gas gap 30 is switched back to partial vacuum p3, and the gas duct 24 is again supplied with stabilizing air having a pressure p2. At this point, partial vacuum thus causes the internal tube 39 to be drawn onto the calibrating mandrel along a short portion of the production line where it is cooled and reinforced. As mentioned above, the internal tube 39 smoothly bears against the external tube 37 without however being pressed into the connecting passages 62 and the overflow passages 63. In this way, the air in the transition portion 64 between the pipe socket 41 and a standard compound pipe 10, which lags relative to the direction of conveying 4, escapes into the subsequent hollow elevation 38.

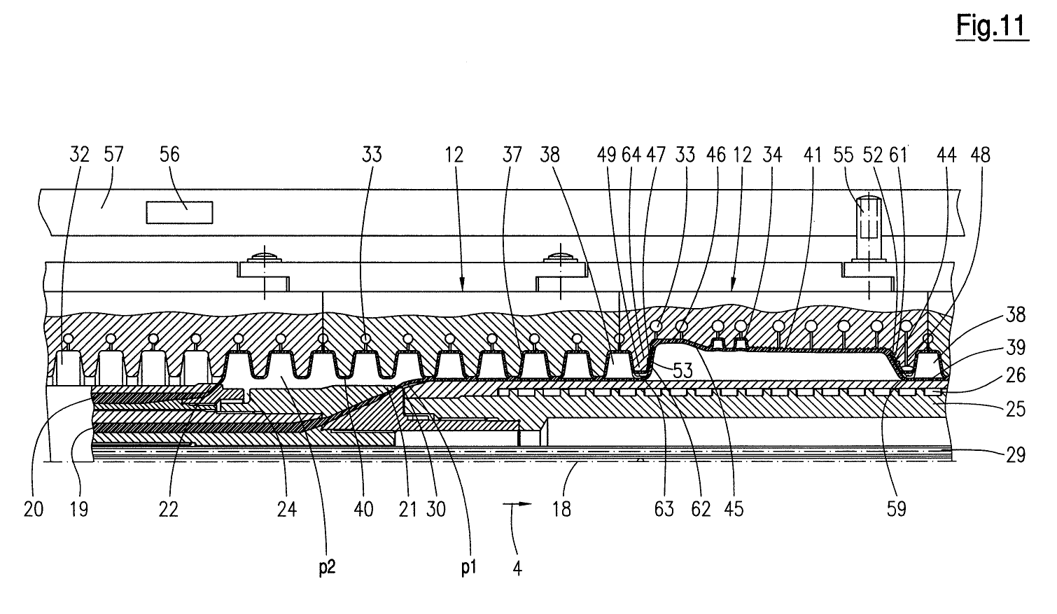

A short distance later, approximately according to FIG. 11, the partial vacuum p3 at the gas gap 30 is again replaced by the overpressure p1, in other words the production conditions are set back to those prevailing during the production of the standard compound pipe 10 which have been described above.

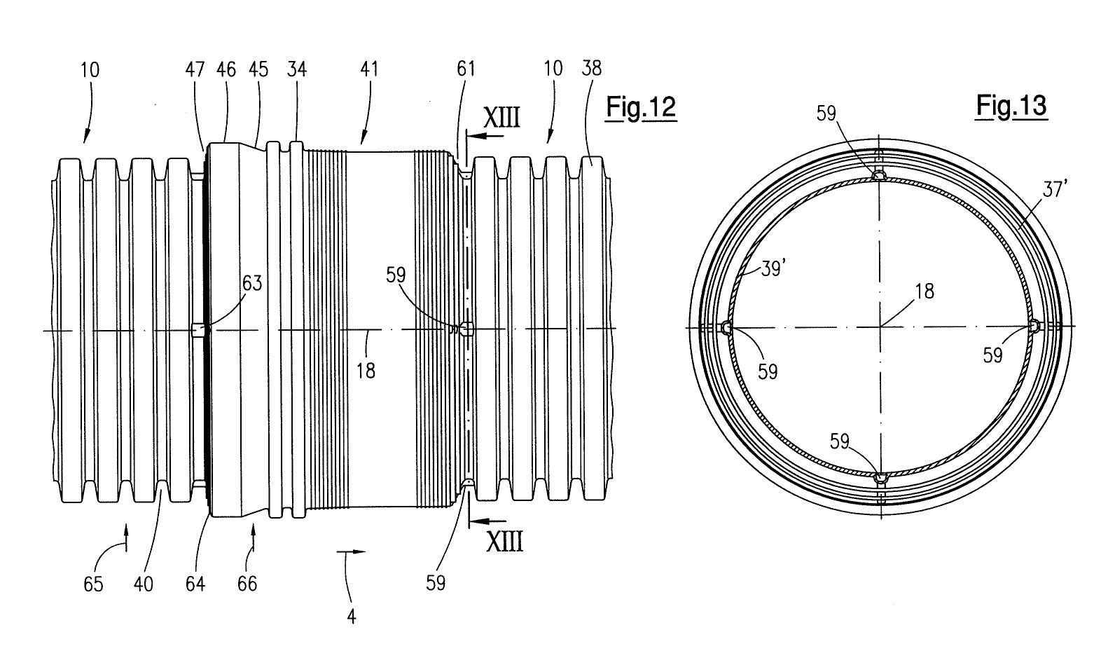

The compound pipe 10 of continuous in-line production, illustrated in particular in FIGS. 12 and 13, is cut through in the vicinity of the transition area 47 that lags in the conveying direction 4; this is done using two cuts 65, 66, wherein cut 65, which that lags in the conveying direction 4, is made through a corrugation trough 40 behind the transition portion 64, while cut 67, which leads in the conveying direction 4, is made along the insert end 46 of the socket 41.

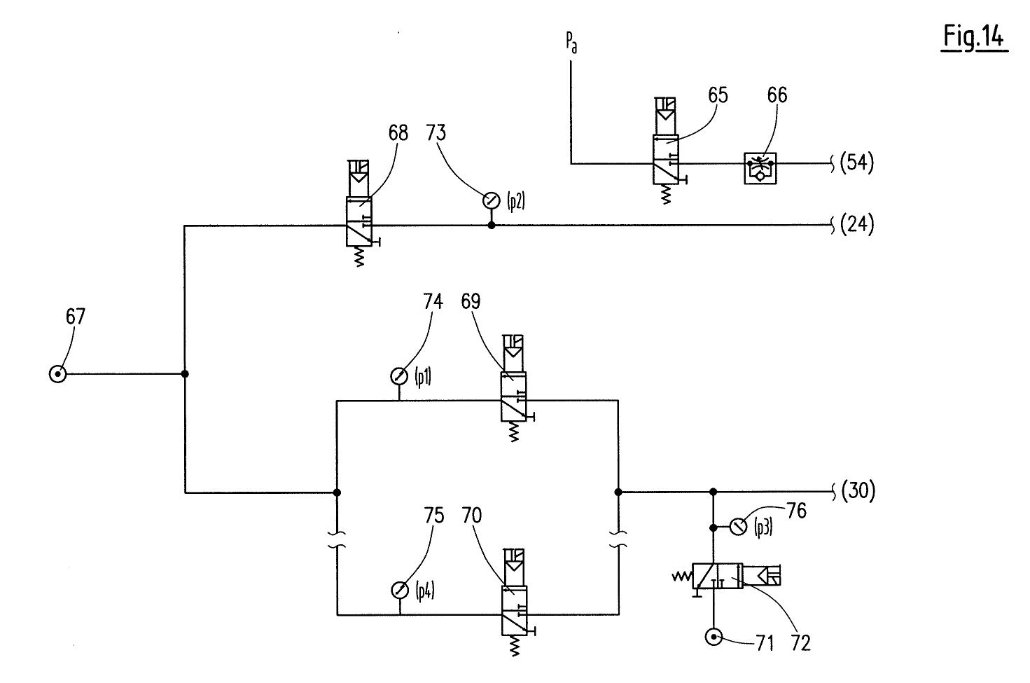

The above-mentioned pressure control systems are illustrated in detail in FIG. 14. The vent duct 54 is connectable to atmospheric pressure pa via a valve 65. Alternatively, the valve 65 can be dispensed with to be replaced by a throttle 66 in the vent duct 54, which throttle 66 may also be formed by a correspondingly narrow cross-section of the vent duct 54. This ensures that when the overpressure p2 is applied to the clearance 58 between the external tube 37 and the internal tube 39, the pressure p2 is maintained in the clearance 58.

The pressure p2 is supplied to the gas duct 24 from a common source 67 of compressed air via a valve 68.

The gas gap 30 is also supplied with the pressure p1 from the source 67 of compressed air via a valve 69. A valve 70 is provided which is arranged in parallel with the valve 69; via said valve 70, the gas gap 30 is supplied with the pressure p4, with naturally either the valve 69 or the valve 70 being open. Furthermore, a partial vacuum source 71 is connected to the gas gap 30 via a valve 72 by means of which the partial vacuum p3 is supplied to the gas gap 30 as described above. Manometers 73, 74, 75, 76 are allocated to the valves 68, 69, 70, 72.

Instead of two extruders 1, 2 and a crosshead 8, it is also conceivable to use a single extruder and a crosshead as known for example from U.S. Pat. No. 5,346,384 and U.S. Pat. No. 6,045,347, to which reference is made. Alternatively, instead of the speed of the extruder, such a design in particular allows the speed of the chains 13, 13′ comprised of half shells 12, 12′ to be changed as well so in order to increase the wall thickness, the speed of the half shells 12, 12′ along the molding path 16 is reduced.

What is claimed is:

1. A method of continuously producing a compound pipe comprising a smooth internal pipe and an external pipe that is welded together with the internal pipe and provided with hollow elevations, a pipe socket, and a central longitudinal axis, the method comprising the following steps:
extruding an external tube concentrically with the central longitudinal axis in a conveying direction;
providing the external tube with corrugations comprising hollow elevations and troughs by partial vacuum applied from outside;
extruding an internal tube into the external tube concentrically with the central longitudinal axis;
passing the internal tube across a calibrating mandrel and welding together the internal tube and the troughs of the external tube;
expanding the external tube at given distances to form an expanded area by applying the partial vacuum from outside so as to produce a pipe socket;
applying a gas at a pressure p4 above atmospheric pressure to the inside of the internal tube and pressing the internal tube full face against the expanded area of the external tube so as to finish the pipe socket; and
forming a transition portion between the pipe socket and an adjacent trough which leads in the conveying direction, the transition portion being comprised of the internal tube and the external tube and directed outwardly in relation to the central longitudinal axis;
wherein the transition portion, in an area between the internal tube and the external tube, is vented into an adjacent hollow elevation by providing the external tube, in the area of the transition portion, with at least one overflow passage that passes through the adjacent trough and extends in the direction of the central longitudinal axis,
wherein prior to forming the overflow passage, there is an overpressure p1 relative to atmospheric pressure pa between the calibrating mandrel and the internal tube, and
wherein while the overflow passage is formed, there is a partial vacuum p3 relative to atmospheric pressure pa between the calibrating mandrel and the internal tube.

2. A method according to claim 1,
wherein after forming the overflow passage, there is an overpressure p4 relative to atmospheric pressure pa in the internal tube while in the clearance between the external tube and the internal tube, there is atmospheric pressure pa.

3. A method according to claim 1,
wherein when the transition portion is formed, the amount of melt, which is supplied per unit time to form the internal tube, is increased.

4. A method according to claim 2,
wherein when the transition portion is formed, the amount of melt, which is supplied per unit time to form the internal tube, is increased.

5. An apparatus for continuously producing a compound pipe comprising a smooth internal pipe and an external pipe that is welded together with the internal pipe and provided with hollow elevations, a pipe socket, and a central longitudinal axis,
wherein half shells are disposed for guided circulation in a conveying direction, which half shells are provided with annular mold recesses and which combine in pairs on a molding path so as to form a mold with a central longitudinal axis;
wherein the mold recesses are connected to partial-vacuum channels in the half shells;
wherein an extrusion head of at least one extruder is disposed upstream of the molding path;
wherein the extrusion head is provided with an outer die for extrusion of an external tube, and with an inner die, which is disposed downstream when seen in the conveying direction, for extrusion of an internal tube, and with a calibrating mandrel at its downstream end relative to the conveying direction;
wherein at least one gas duct exits the extrusion head between the outer die and the inner die;
wherein at least one additional gas duct exits the extrusion head between the inner die and the calibrating mandrel which may be supplied with both overpressure p1 relative to atmospheric pressure pa as well as partial vacuum p3;
wherein at least one pair of half shells is provided with a socket recess;
wherein a transition area, which is directed outwardly in relation to the central longitudinal axis, is formed on an annular rib that is located between the socket recess and an adjacent mold recess leading in the conveying direction;
wherein a recess is provided in the annular rib which recess connects the transition area with said adjacent annular mold recess for forming a hollow elevation,
wherein relative to the conveying direction, a vent duct exits between the outer die and the inner die, the vent duct being continuously connected to atmosphere.

6. An apparatus according to claim 5,
wherein the vent duct has a throttling effect.
